(19) United States
(12) Patent Application Publication
(10) Pub. No.: US 2025/0386174 A1
(43) Pub. Date: Dec. 18, 2025

(54) METHOD FOR ASSISTING A DOCKING PROCEDURE BY A VEHICLE, CONTROL UNIT, VEHICLE, AND COMPUTER PROGRAM

(71) Applicant: ZF CV Systems Global GmbH, Bern (CH)

(72) Inventors: Daniel PFEFFERKORN, Hannover (DE); Andelko GLAVINIC, Sarstedt (DE); Thomas WOLF, Barsinghausen (DE); Niklas BROLL, Ronnenberg (DE)

(21) Appl. No.: 19/235,677

(22) Filed: Jun. 12, 2025

(30) Foreign Application Priority Data
Jun. 13, 2024 (DE) 10 2024 116 661.4

(51) Int. Cl. H04W 4/80; B60Q 9/00; B60T 7/22; B60W 30/06; B60W 60/00; H04W 4/024; H04W 4/44; H04W 76/15

(52) U.S. Cl. CPC H04W 4/80; B60Q 9/008; B60T 7/22; H04W 4/024; H04W 4/44; H04W 76/15; B60W 30/06; B60W 60/001; B60W 2554/404; B60W 2556/45

(57) ABSTRACT

The disclosure provides a method for assisting a docking procedure by a vehicle to a specified loading dock of a logistics facility having a plurality of loading docks. Short-range radio communication is established between the loading docks and the vehicle using a short-range radio signal including an identifier. The specified loading dock and/or the vehicle is identified based on the identifier in the short-range radio signal. The specified loading dock and/or the vehicle is identified is located based on at least one signal incident angle (a) of the short-range radio signal, and/or at least one time-of-flight measurement of the short-range radio signal (31). The specified loading dock and/or the vehicle is driven up using the short-range radio signal for navigating the vehicle to the specified loading dock.

### CROSS REFERENCE TO RELATED APPLICATIONS

This application claims benefit to German Patent Application No. DE 10 2024 116 661.4 filed on Jun. 13, 2024, which is hereby incorporated by reference herein.

### FIELD

The disclosure relates to a method for assisting a docking procedure by a vehicle, in particular a commercial vehicle, to a specified loading dock of a logistics facility having a plurality of loading docks. The disclosure also relates to a control unit for a vehicle, in particular a commercial vehicle. In addition, the disclosure relates to a vehicle, in particular a commercial vehicle, and to a computer program.

### BACKGROUND

In logistics facilities having loading docks which, for example, can provide access to a warehouse and up to which vehicles can drive for the purpose of loading or unloading the vehicle, there are high requirements for economic and safe operation of the logistics facility, for instance through efficient coordination of the vehicles driving up to the logistics facility and through suitable preventive and safety measures for avoiding accidents between the vehicles and stationary or moving objects of the logistics facility. As part of the increasing digitization and electrical networking in logistics facilities, efforts exist to optimize, or at least partially automate, for instance by technical communication solutions, the operation of the logistics facility and the vehicles intended to drive up to the logistics facility.

For example, EP 3 489 176 A1 discloses a system for monitoring and controlling docking and undocking procedures between a loading station and an autonomous or semi-autonomous truck. The loading station is assigned a first control apparatus, which is used to control an access door and a loading ramp of the loading station. On board the truck is arranged a second control apparatus, which is used to control a propulsion mechanism, an access door and an immobilizer of the truck. The control apparatuses are each assigned a communication means, which communicate wirelessly with each other by sending and receiving clearance signals. The aim here is to be able to ensure, for example, timely opening and closing of the access door to the loading station and the loading ramp.

WO 2021/053611 A1 discloses various centrally controlled commercial vehicle concepts including tractor and trailer vehicles for monitoring and optimizing transport tasks. For example, satellite navigation systems and other communication technologies such as Bluetooth or RFID, for instance, can be deployed here for determining location and vehicle monitoring.

The existing concepts for providing technical assistance to the operation of logistics facilities and to the vehicles driving up to the logistics facility have further potential for development as regards solutions that are precise and safe yet still technically simple for assisting docking procedures in logistics facilities. In particular, it should be possible to simplify and speed up the driving-up to a specified loading dock of the logistics facility.

### SUMMARY

In an embodiment, the present disclosure provides a method for assisting a docking procedure by a vehicle to a specified loading dock of a logistics facility having a plurality of loading docks. The method comprises establishing short-range radio communication between the loading docks and the vehicle using a short-range radio signal containing an identifier; identifying the specified loading dock and/or the vehicle based on the identifier in the short-range radio signal; locating the specified loading dock and/or the vehicle based on at least one signal incident angle (α) of the short-range radio signal and/or at least one time-of-flight measurement of the short-range radio signal; and driving up to the specified loading dock using the short-range radio signal for navigating the vehicle to the specified loading dock.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic diagram of a logistics facility having a plurality of loading docks and vehicles for illustrating a method for assisting a docking procedure according to a first embodiment;

FIG. 2 shows a schematic diagram of a logistics facility having a plurality of loading docks and vehicles for illustrating a method for assisting a docking procedure according to a second embodiment;

FIG. 3 shows a schematic diagram of a logistics facility having a plurality of loading docks and vehicles for illustrating a method for assisting a docking procedure according to a third embodiment;

FIG. 4 shows a schematic diagram of a logistics facility having a plurality of loading docks and vehicles for illustrating a method for assisting a docking procedure according to a fourth embodiment;

FIG. 5 shows a schematic diagram of a logistics facility having a plurality of loading docks and vehicles according to a fifth embodiment for illustrating a first locating principle of the method for assisting a docking procedure;

FIG. 6 shows a schematic diagram of a logistics facility having a plurality of loading docks and vehicles according to a sixth embodiment for illustrating a second locating principle of the method for assisting a docking procedure; and

FIG. 7 shows a simplified flow diagram of the method for assisting a docking procedure.

### DETAILED DESCRIPTION

In accordance with an embodiment, the present disclosure provides an improved method for assisting a docking procedure by a vehicle to a specified loading dock, by which reliable, precise and easy-to-implement assistance for the docking procedure can be achieved.

In accordance with another embodiment, the present disclosure provides a method for assisting a docking procedure by a vehicle, in particular a commercial vehicle, to a specified loading dock of a logistics facility having a plurality of loading docks, having the steps:
establishing short-range radio communication between the loading docks and the vehicle using a short-range radio signal containing an identifier;
identifying the specified loading dock and/or the vehicle on the basis of the identifier in the short-range radio signal;
locating the specified loading dock and/or the vehicle on the basis of at least one signal incident angle of the short-range radio signal and/or at least one time-of-flight measurement of the short-range radio signal; and
driving up to the specified loading dock using the short-range radio signal for navigating the vehicle to the specified loading dock.

Put simply, embodiments of the present disclosure provide a vehicle intended for docking to a specific loading dock and the loading dock are assigned to one another, and that the vehicle is guided by means of short-range radio signals to the specified loading dock in a targeted manner. The use of short-range radio communication can facilitate precise and reliable assistance of docking procedures that can be implemented easily and at low cost. The assignment of the vehicle and the specified loading dock to one another can be made here regardless of visual circumstances and light conditions, whereby an advantage can be achieved over, for example, camera-based localization and navigation approaches. The short-range radio signal can be used to locate the specified loading dock and/or the vehicle very precisely. For example, by a triangulation method, signal-based transmitter distance determination and/or a signal time-of-flight measurement, as described in greater detail below, position and distance determination can be realized with an accuracy that cannot be achieved with known methods for assisting docking procedures. In addition, the short-range radio communication can be established and operated by simple means, and therefore an advantage can be achieved over more complex and more costly detection systems such as LIDAR instruments, for example. The short-range radio communication used for the disclosed method can have a higher precision compared with satellite-based location-finding approaches such as the Global Navigation Satellite System (GNSS). By the inclusion of an identifier in the short-range radio signal, it is also possible to identify definitively the specified loading dock and/or the vehicle, allowing the vehicle to be guided swiftly and safely to the specified loading dock.

A docking procedure can be understood to mean, in the context of the present application, a procedure in which a vehicle approaches a loading dock until contact is made between the loading dock and the vehicle. In particular, a docking procedure can include the vehicle approaching by driving up in a reverse direction of the vehicle so that a rear loading and unloading entrance of the vehicle is facing the loading dock. The docking procedure can optionally also comprise opening the loading and unloading entrance and/or opening a closable loading bay of the loading dock during the drive-up process.

A loading dock can be a structural means for loading and unloading from vehicles, for example a loading ramp or loading bridge. The loading dock can have a loading bay that can be closed by a roller shutter, for example. A specified loading dock according to the features of the present disclosure can refer to a loading dock of a plurality of loading docks of the logistics facility, which loading dock is designated, for example by a logistics management system of the logistics facility, specifically for the vehicle for a loading and/or unloading procedure. A logistics facility can be viewed as a logistically interconnected structural unit, which can be embodied, for example, as a warehouse, as an industrial building or as a logistics center comprising a plurality of buildings.

The vehicle according to the features of the present disclosure can be a road vehicle, in particular a commercial vehicle such as a transport vehicle for transporting goods. For example, the vehicle can be in the form of a structurally interconnected unit, for instance a transporter, or a vehicle team of at least two mutually connected vehicle units. For example, the vehicle team can have a tractor vehicle and a trailer vehicle. The vehicle team can be embodied as a semitrailer, for example. Depending on the embodiment, the vehicle can be, for example, a conventional, semi-automated or fully automated vehicle. In the case of a conventional vehicle, the assisting of the docking procedure can be realized as part of a driver assistance program, so that the procedure of driving up to the loading dock is controlled mainly by a driver of the vehicle. In the case of a semi-automated or fully automated vehicle, the assisting of the docking procedure can be realized as part of an automatic driving program, so that the procedure of driving up to the loading dock is controlled mainly by a vehicle controller of the vehicle.

In the context of the present application, short-range radio communication can be understood to mean data communication between a radio transmitter and a radio receiver with a limited range, for example with a range of less than 500 m, in particular less than 100 m or less than 50 m. According to the features of the disclosed method, in a method step, short-range radio communication is established between the loading docks and the vehicle using a short-range radio signal containing an identifier. Such an identifier can be regarded as a unique label of a loading dock or of a vehicle. For example, the identifier can be embodied as an identification number. Identification of the specified loading dock and/or the vehicle on the basis of the identifier in the short-range radio signal can be made, for example, by comparing the identifier transmitted by the short-range radio signal with a plurality of identifiers held in an electronic storage means of the logistics facility and/or of the vehicle and with the information associated with the identifiers. The information associated with the identifiers can be used, for example, to ascertain a specified loading dock from a plurality of loading docks for the vehicle. The identifiers and the information associated therewith can be stored, for example, in a look-up table of a logistics management system of the logistics facility. The loading docks can each have a control device or a shared control means, which can access, for example, the electronic storage means of the logistics facility.

According to the features of the disclosed method, in a further method step, the specified loading dock and/or the vehicle is located on the basis of a signal incident angle of the short-range radio signal. In other words, the specified loading dock can determine on the basis of the signal incident angle of the short-range radio signal a relative position of the vehicle to the loading dock, as explained in greater detail below in connection with advantageous embodiments. Alternatively or additionally, the vehicle can determine on the basis of the signal incident angle of the short-range radio signal a relative position of the specified loading dock to the vehicle. For this purpose, the loading dock and/or the vehicle has a radio signal receiver intended for the short-range radio communication, which is configured to determine the signal incident angle of the received short-range radio signal, and a control unit or control means, which is configured to ascertain from the determined signal incident angle a relative position of the specified loading dock and/or of the vehicle with respect to each other. Since it is the vehicle performing the relative approach in the docking procedure, the specified loading dock can be configured to communicate via the short-range radio communication or another communication channel, for instance a Vehicle2x channel such as dedicated short range communication (DSRC), to the vehicle a relative position of the vehicle ascertained by the loading dock, if the relative position is ascertained on the basis of a short-range radio signal of the vehicle received at a short- range radio signal receiver of the loading dock. The locating of the specified loading dock and/or of the vehicle can comprise in particular continuous relative position-determination in order to be able to assist the docking procedure precisely and guide the vehicle to the specified loading dock with high accuracy.

According to features of the disclosed method, in a further method step, driving up to the specified loading dock is performed using the short-range radio signal for navigating the vehicle to the specified loading dock. Accordingly a, in particular continuously updated, control instruction for a driver or for a vehicle controller of the vehicle for driving up to the specified loading dock with targeted precision can accordingly be derived, for example, from the determined relative position on the basis of the signal incident angle.

In principle, the disclosed method steps can be implemented by means of a control unit of the vehicle. For example, the control unit can be in the form of a central cross-functional vehicle control device of the vehicle or a distributed control unit for controlling selected vehicle functions. The control unit can be a processor-based control unit, in particular a microprocessor-based control unit. The control unit can have a computing unit for processing information and a memory unit for storing information. The method can comprise suitable filter processes and plausibility checks for increasing the accuracy and safety of the assisted docking procedure.

According to an embodiment, the short-range radio communication can be based on Bluetooth communication and the short-range radio signal can be in the form of a Bluetooth signal. This can achieve favorable ranges of the short-range radio communication for assisting a docking procedure. In addition, Bluetooth communication can be associated with low power consumption. Furthermore, locating-functions that use Bluetooth communication can be realized easily by appropriate standards. For example, triangulation methods, signal-based transmitter distance determinations and/or signal time-of-flight measurements can be implemented with high precision using modern Bluetooth equipment. Bluetooth transmitters and receivers can be small in size and lightweight and have, for example, a battery-based power supply. Accordingly, Bluetooth communication can facilitate assistance of docking procedures that is easy and low-cost to realize. For example, the Bluetooth communication can be based on Bluetooth Low Energy technology (BLE technology), which has a sufficient range for assisting a docking procedure with increasing accuracy as the vehicle approaches the loading dock, and is associated with particularly low power consumption. In principle, however, another short-range radio technology such as RFID, for example, is not ruled out in the present application.

According to an embodiment, the vehicle can have at least one short-range radio receiver, and the loading docks can each have at least one short-range radio transmitter. Short-range radio transmitters at the loading docks can be designed to have high powers and signal ranges thanks to a possible stationary power supply. Furthermore, no additional communication steps are needed between the specified loading dock and the vehicle, for instance in order to transmit to the vehicle a locating result determined by means of the short-range radio receiver from the signal incident angle of the short-range radio signal or a monitoring result (to be explained below) regarding moving objects in a docking area, but instead this vehicle can use the short-range radio receiver to carry out directly the locating of the specified loading dock or monitoring of the docking area. A short-range radio receiver can be a radio unit for receiving a radio signal. For example, the short-range radio receiver can be embodied as Bluetooth receiver. Depending on the chosen embodiment, the short-range radio receiver can be configured solely or in combination with at least one further short-range radio receiver to capture the signal incident angle of the short-range radio signal, in particular to determine a relative position of the vehicle to the specified loading dock on the basis of the signal incident angle. A short-range radio transmitter can be a radio unit for emitting a radio signal. For example, the short-range radio transmitter can be embodied as Bluetooth transmitter or Bluetooth tag. A Bluetooth transmitter can be understood to mean in particular a stationary Bluetooth transmitter. A Bluetooth tag can be understood to mean in particular a mobile, for example portable, Bluetooth device, which can be fastened, for instance, on a moving object such as a secondary vehicle, for example a forklift, or on a person. The vehicle can have at least one short-range radio receiver and/or at least one short-range radio transmitter on a rear loading and unloading entrance, wherein optionally at least one further short-range radio receiver and/or at least one further short-range radio transmitter can be arranged on a side vehicle-region or a vehicle front of the vehicle. The short-range radio receiver(s) and/or the short-range radio transmitter(s) can be arranged in particular on an external surface of the vehicle in order to achieve optimized signal propagation between a short-range radio transmitter and a short-range radio receiver for establishing the mentioned short-range radio communication.

According to an embodiment, the vehicle can have at least one short-range radio transmitter, and the loading docks can each have at least one short-range radio receiver. This shifts the focus to vehicle management by the logistics facility, which allows active coordination of vehicles arriving at the logistics facility, for instance by means of a logistics management system of the logistics facility. Accordingly, in contrast with vehicle-based locating of a specified loading dock, facility-based assignment of a vehicle to the loading dock using suitable locating can also be provided, which can be associated with, for example, more flexible and more dynamic allocation of vehicles across the logistics facility.

In principle, the above-described embodiments can also be combined with each other, so that the vehicle has at least one short-range radio receiver and one short-range radio transmitter and/or the loading docks each have at least one short-range radio receiver and at least one short-range radio transmitter. This allows particularly flexible or else, for instance, redundant and hence failsafe establishment of short-range radio communication.

According to an embodiment, a triangulation method can be performed for locating the specified loading dock and/or the vehicle on the basis of the signal incident angle of the short-range radio signal. This allows precise and reliable locating of the specified loading dock and/or of the vehicle with an accuracy that cannot be achieved with known methods for assisting docking procedures. For a triangulation method, at least two short-range radio receivers and/or a receiver array can be provided at each of the loading docks and/or at the vehicle for jointly ascertaining the signal incident angle of the short-range radio signal via a triangulation method. A relative position of a short-range radio transmitter arranged at the vehicle can thereby be determined with high accuracy. The locating by means of the triangulation method can be assisted additionally by a signal transit-time measurement.

According to an embodiment, the locating of the specified loading dock and/or of the vehicle can be performed on the basis of signal-based transmitter distance determination. This allows precise locating of the specified loading dock and/or of the vehicle with just a single short-range radio receiver and with an accuracy that cannot be achieved with known methods for assisting docking procedures. For example, in modern Bluetooth systems, a Bluetooth receiver can be configured to transmit a special locating signal to the Bluetooth transmitter and, based on the response therefrom, determine a distance between the Bluetooth receiver and the Bluetooth transmitter. Advantageously, the locating of the specified loading dock and/or of the vehicle can be performed on the basis of determining the signal incident angle and signal-based transmitter distance determination in combination.

According to an embodiment, a docking area between the specified loading dock and the vehicle can be monitored during the driving-up to the specified loading dock for an existing or likely presence of a moving object that has a short-range radio transmitter. Accordingly, the short-range radio communication can be used advantageously not only for locating and navigation tasks but also for increasing the safety of the docking procedure. A short-range radio transmitter can be arranged simply and at low cost, for instance as a Bluetooth tag, on moving objects such as a secondary vehicle or a person, for example, which are then easily detectable by a short-range radio receiver of the specified loading dock and/or of the vehicle on the basis of a short-range radio signal received from the short-range radio transmitter. The described docking area can be regarded here as a spatially defined safety zone between the vehicle and the specified loading dock, which safety zone can be allotted by the vehicle or the logistics facility. The presence monitoring can optionally be performed conditionally, for example depending on a reversing mode of the vehicle or from a specified distance onwards between the specified loading dock and the vehicle. Depending on the chosen embodiment and corresponding radio transmitter/radio receiver arrangement in the vehicle and at the loading docks, a monitoring result of the presence monitoring can be determined in the vehicle or determined by the specified loading dock and communicated to the vehicle, for example via the short-range radio communication or another communication channel, for instance a Vehicle2x channel such as DSRC. The docking procedure by the vehicle can thereby be controlled, for instance interrupted, depending on the monitoring result.

According to an embodiment, on detection of the moving object present in the docking area, classification and/or identification of the moving object can be carried out. For example, the short-range radio signal emitted by the short-range radio transmitter of the moving object can comprise an object label of the moving object. The classification can be made, for example, according to the type of the moving object, for instance in order to be able to distinguish between people and secondary vehicles. By classifying and/or identifying the moving object detected in the docking area, a suitable response on the part of the vehicle driving up to the loading dock can be adjusted according to the situation to suit the classified and/or identified moving object, and a high level of safety can be guaranteed while the docking procedure is taking place.

According to an embodiment, on detection of the moving object present in the docking area, object locating and/or a trajectory calculation for the moving object can be carried out. Accordingly, the moving object can be located precisely on the basis of a short-range radio signal emitted by the short-range radio transmitter, for example on the basis of a signal incident angle captured at a short-range radio receiver of the loading dock and/or vehicle, in particular using a triangulation method or signal-based transmitter distance determination. In particular, it is conceivable to carry out a trajectory calculation for the moving object on the basis of the captured short-range radio signal in order to assess a potential collision with the loading dock or the vehicle. An instantaneous position and/or a captured change in position of the moving object can thereby be included in a decision about a suitable response to the classified and/or identified moving object on the part of the vehicle driving up to the loading dock.

According to an embodiment, in response to detecting the moving object present in the docking area, a braking procedure can be initiated at the vehicle and/or a warning message can be output at the vehicle and/or the specified loading dock. It is thereby possible to implement effective safety measures on detection of the presence of a moving object in the docking area. The braking procedure by the vehicle can comprise in particular decelerating until the vehicle is at a standstill. Optionally, the braking procedure can be performed under emergency braking conditions. The warning message can include, for example, a visually, audibly and/or haptically perceptible alarm to a driver in the vehicle and/or a visual and/or audible alarm at the loading dock.

The disclosure also relates to a control unit for a vehicle, in particular a commercial vehicle, which is connectable or connected for signal communication to a short-range radio receiver and/or a short-range radio transmitter of the vehicle, and is configured to perform the method according to one of the above-described features. The above-described method can be implemented by the control unit efficiently in a vehicle which is intended to perform a docking procedure at a specified loading dock of a logistics facility having a plurality of loading docks, and therefore the above-described advantages of reliable, precise and easily implementable assistance for the docking procedure are achievable by the control unit. The control unit can be configured to establish short-range radio communication between the loading docks and the vehicle using a short-range radio signal containing an identifier. The control unit can be configured to identify the specified loading dock on the basis of the identifier in the short-range radio signal, and/or to receive information from the specified loading dock relating to identifying the vehicle that comprises the control unit. The control unit can be configured to locate the specified loading dock on the basis of a signal incident angle of the short-range radio signal, and/or to receive information from the specified loading dock relating to locating the vehicle that comprises the control unit. The control unit can be configured to assist driving up to the specified loading dock using the short-range radio signal for navigating the vehicle to the specified loading dock, for example by outputting a control instruction to the driver or by assisting a drive-up procedure performed semi-automatically or fully automatically by the control unit. For example, the control unit can be in the form of a central cross-functional vehicle control device of the vehicle or a distributed control means for controlling selected vehicle functions. The control unit can be a processor-based control unit, in particular a microprocessor-based control unit. The control unit can have a computing unit for processing information and a memory unit for storing information. In the memory unit can be held, for example, a computer program (to be described below) for performing the above-described method. A short-range radio receiver and/or a short-range radio transmitter of the vehicle can be connectable or connected for signal communication to the control unit, for example in a wireless or wired manner. In addition to the mentioned short-range radio communication, the control unit can be connectable for signal communication to at least one loading dock via a further, in particular wireless, communication channel, for instance a Vehicle2x channel such as DSRC. The control unit can be connectable or connected to an output means in a driver's cab region, for instance in order to be able to output in a manner that is noticeable to the driver of the vehicle a control instruction for driving up to the specified loading dock or a warning message about a moving object detected in the docking area.

The disclosure also relates to a vehicle, in particular a commercial vehicle, having at least one short-range radio receiver and/or at least one short-range radio transmitter and a control unit according to one of the above-described features. The above-described method can also be implemented by the vehicle efficiently using the short-range radio receiver and/or the short-range radio transmitter and the control unit, and therefore the above-described advantages of reliable, precise and easily implementable assistance for the docking procedure are achievable by the vehicle. For example, the vehicle can be in the form of a structurally interconnected unit, for instance a transporter, or a vehicle team of at least two mutually connected vehicle units. For example, the vehicle team can have a tractor vehicle and a trailer vehicle. The vehicle team can be embodied as a semitrailer, for example. The vehicle can be a conventional vehicle, for example. In the case of a conventional vehicle, the assisting of the docking procedure can be realized as part of a driver assistance program, so that the procedure of driving up to the loading dock is controlled mainly by a driver of the vehicle.

According to an embodiment, the vehicle can be in the form of a semi-automated or fully automated vehicle, and be configured for an automatic drive-up procedure to the specified loading dock using the short-range radio signal. This allows a docking procedure that can be performed particularly conveniently and safely. The control unit of the vehicle can be configured here to perform the automatic drive-up procedure through intervention in the control functions of the vehicle.

The disclosure also relates to a computer program comprising machine-readable instructions which, on execution of the instructions by a computing unit cause this to perform the method according to one of the above-described features. The computing unit can be, for example, a computing unit of a vehicle control device, in particular a computing unit of the above-described control unit. By means of the computer program, complex communication, identification, locating and navigation processes can be processed, so that the above-described method can be implemented with high accuracy and reliability by means of the computer program.

In general, the words “a/an”, unless explicitly stated otherwise, are not intended here in the sense of a quantifier but as an indefinite article with the literal meaning of “at least one”.

The disclosure allows various embodiments, and is explained in more detail below with reference to exemplary embodiments with the accompanying drawings, in which schematically:

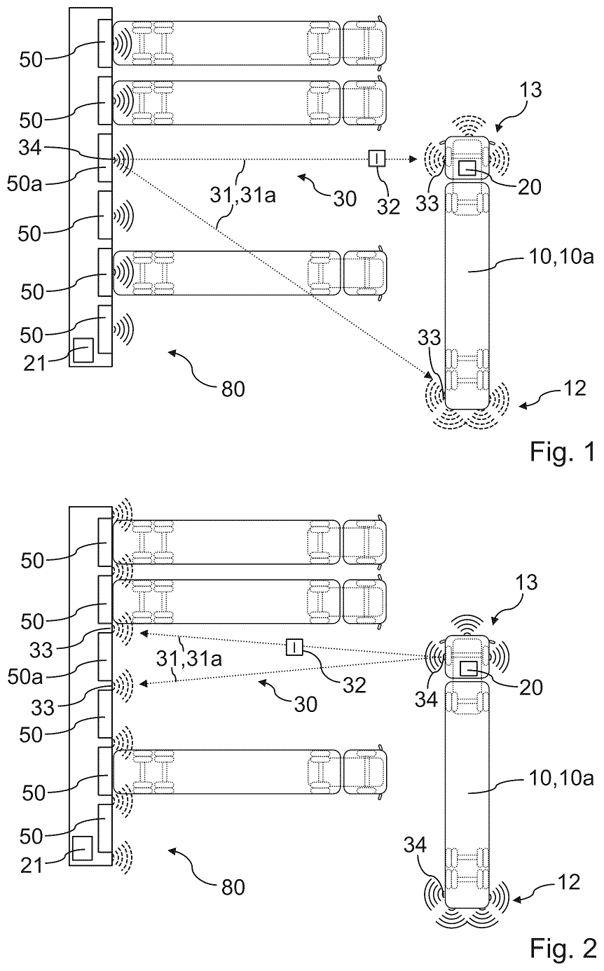

FIGS. 1 to 6 show schematically a logistics facility 80 having a plurality of loading docks 50. Also depicted are vehicles 10 in the form of commercial vehicles 10a, here in the form of semitrailers, of which a plurality of vehicles 10 are already docked at loading docks 50, and a further vehicle 10 is arriving at the logistics facility 80 and is intended to dock at a specified loading dock 50a.

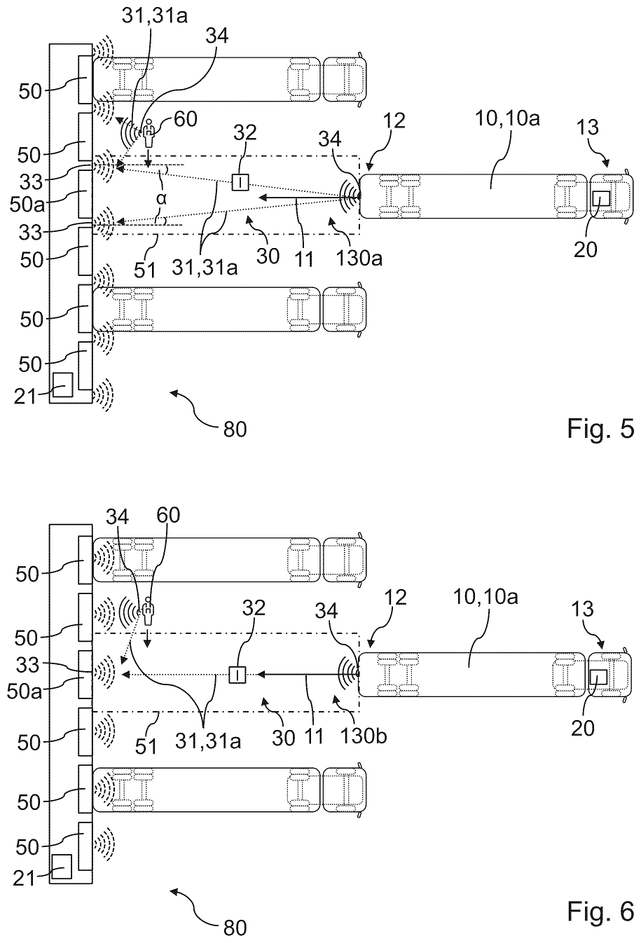

According to the first exemplary embodiment, which is shown in FIG. 1, each loading dock 50 has a short-range radio transmitter 34, and the vehicle 10 has a plurality of short-range radio receivers 33 at a rear 12 and in the front region 13 of the vehicle 10. The short-range radio transmitters 34 of the loading docks 50 and the short-range radio receivers 33 of the vehicle 10 can be used to establish short-range radio communication 30, for instance based on Bluetooth communication, between the loading docks 50 and the vehicle 10. A short-range radio signal 31, which is in the form of a Bluetooth signal 31a according to the exemplary embodiment shown, can be transmitted from the short-range radio transmitters 34 of the loading docks 50 to the short-range radio receivers 33 of the vehicle 10. The short-range radio signal 31 contains, as indicated schematically, an identifier 32, on the basis of which the vehicle 10 can identify a specified loading dock 50a, which is intended for a docking procedure by the arriving vehicle 10. In addition, the arriving vehicle 10 can locate by its short-range radio receiver 33 the specified loading dock 50a by way of the short-range radio receivers 33 capturing a signal incident angle a, which is shown by way of example in FIG. 5, and, for example, a control unit 20 of the vehicle 10 being used to determine a relative position of the specified loading dock 50a to the vehicle 10. The control unit 20 of the vehicle 10 is connected via a signal connection (not presented further here) to the short-range radio receivers 33 of the vehicle 10. For the purpose of capturing the signal incident angle, an antenna array can be employed in the case of Bluetooth communication. This may be a linear or planar antenna array. In the case of a linear antenna array, a number of antennas are arranged in a row. In the case of a planar antenna array, the antennas are arranged in a plurality of rows in a plane. As an example, for instance in the case of a linear antenna array, 15 antennas could be arranged in a row. The distance between the antennas is defined and can equal, for example, λ/4, i.e. a quarter of the wavelength. In Bluetooth communication the frequencies lie in the ISM band at 2.4 GHz. A quarter of the wavelength thus equals a distance of 3.1 cm. The incident angle of a radio signal can be calculated if the signal phase θ at each antenna, the wavelength λ and the distance d between adjacent antennas are known. Version 5.1 of the Bluetooth standard already provides this functionality of ascertaining the signal incident direction. Likewise, “beamsteering”, i.e. radiating the signal into a specific direction, can also be provided. The two direction-finding techniques are known by the terms “Angle of Arrival” (AoA) and “Angle of Departure” (AoD). The Angle of Arrival technique can be used to ascertain the signal incident angle. The above-described locating-function can be used to simplify the driving-up to the specified loading dock 50a by the vehicle 10 using the short-range radio signal 31 for navigating the vehicle 10 to the specified loading dock 50a, for example to output suitable control instructions to a driver of the vehicle 10 or to realize a semi-automatic or fully automatic drive-up procedure. As a result, the docking procedure can advantageously be assisted in a reliable, precise and easy-to-implement way. At the rear 12 of the vehicle 10 can be provided a loading and unloading entrance (not presented in greater detail) of the vehicle 10, for example a tailgate. The loading docks 50 can have an access bay (not presented in greater detail), which can be closed by a roller shutter, for example. The loading and unloading entrance of the vehicle 10 and the access bay can optionally be opened already during a docking procedure by the vehicle 10.

According to the second exemplary embodiment, which is shown in FIG. 2, each loading dock 50 has a plurality of short-range radio receivers 33, and the vehicle 10 has a plurality of short-range radio transmitters 34 at the rear 12 and in the front region 13 of the vehicle 10. The short-range radio receivers 33 of the loading docks 50 and the short-range radio transmitters 33 of the vehicle 10 can also be used to establish short-range radio communication 30, for instance based on Bluetooth communication, between the loading docks 50 and the vehicle 10. A short-range radio signal 31, which is in the form of a Bluetooth signal 31a according to the exemplary embodiment shown, can be transmitted from the short-range radio transmitters 34 of the vehicle 10 to the short-range radio receivers 33 of the loading docks 50. The short-range radio signal 31 contains, as indicated schematically, an identifier 32, on the basis of which the arriving vehicle 10, which is intended for a docking procedure to a specified loading dock 50a, can be identified. In addition, the specified loading dock 50a can locate by its short-range radio receiver 33 the arriving vehicle 10 by way of the short-range radio receivers 33 capturing a signal incident angle α, which is shown by way of example in FIG. 5, and, for example, a control means 21 of the loading docks being used to determine a relative position of the specified loading dock 50a to the vehicle 10. The control means 21 of the loading docks 50 is connected via a signal connection (not presented further here) to the short-range radio receivers 33 of the loading docks 50. The control means 21 can also be configured to transmit to the control unit 20 of the vehicle 10 the determined relative position of the vehicle 10 to the specified loading dock 50a, for example via an additional communication channel, for instance based on Vehicle2x, such as DSRC, so that the locating-function of the loading docks 50 can be used for navigating the vehicle 10 to the specified loading dock 50a. For example, suitable control instructions can be output to a driver of the vehicle 10 or a semi-automatic or fully automatic drive-up procedure can be realized. As a result, the docking procedure can advantageously be assisted in a reliable, precise and easy-to-implement way.

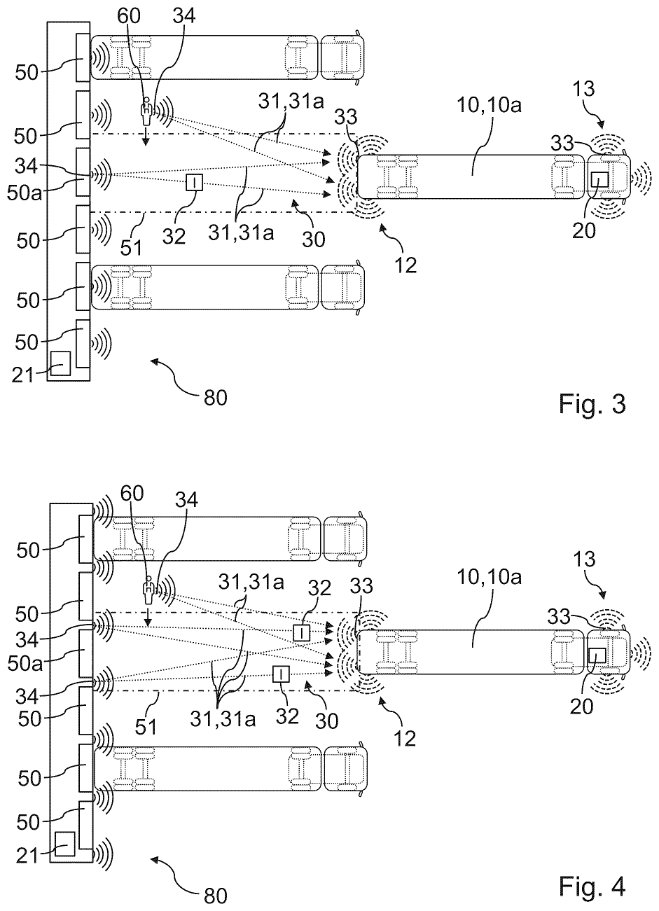

The third exemplary embodiment, which is depicted in FIG. 3, is largely similar to the first exemplary embodiment, depicted in FIG. 1, as regards the arrangement of short-range radio transmitters 34 at the loading docks 50 and of short-range radio receivers 33 at the vehicle 10. FIG. 3 shows that the arriving vehicle 10 is already oriented with the rear region 12 facing the specified loading dock 50a, and is ready to reverse up to the specified loading dock 50a. In this case, according to the third exemplary embodiment, the vehicle 10 is configured to monitor during the driving-up to the specified loading dock 50a a docking area 51 between the specified loading dock 50a and the vehicle 10 for the existing or likely presence of a moving object 60 having a short-range radio transmitter 34. For this purpose, the moving object 60, which according to the exemplary embodiment shown is embodied as a person, has a portable short-range radio transmitter 34, for example a Bluetooth tag, which emits a short-range radio signal 31, for example in the form of a Bluetooth signal 31a, which can be received by the short-range radio receivers 33 of the vehicle 10. In particular, the vehicle 10 can be configured to carry out object locating and/or a trajectory calculation for the moving object 60 on the basis of the short-range radio signal 31. If the moving object 60 is detected in the docking area 51 or if the moving object 60 is expected to enter the docking area 51, a braking procedure can be initiated at the vehicle 10 and/or a warning message can be output, for example.

The fourth exemplary embodiment, which is depicted in FIG. 4, is similar to the third exemplary embodiment, which is depicted in FIG. 3, with regard to the fundamental design and fundamental operating principle. In this case, however, a plurality of short-range radio transmitters 34 are provided at each of the loading docks 50, whereby the accuracy of the locating and navigation functions by means of the short-range radio communication 30 can be increased.

The fifth exemplary embodiment, which is depicted in FIG. 5 and in which the vehicle 10 is approaching the specified loading dock 50a in a reverse driving direction 11, shall be used to illustrate in particular a first possible locating principle by means of the short-range radio communication 30 on the basis of the signal incident angle a. In this case, the loading docks 50 each have a plurality of short-range radio receivers 33. At least two of the short-range radio signal receivers 33 of the loading docks 50, in particular of the specified loading dock 50a, can be configured to capture the short-range radio signal 31 transmitted by a short-range radio signal transmitter 34 <> of the vehicle 10 with regard to the signal incident angle α. In order to determine the relative position of the short-range radio signal transmitter 34 of the vehicle 10, a triangulation method can be performed, for example by means of the control means 21 of the loading docks 50, on the basis of the signal incident angle a captured by the short-range radio signal receivers 33 <>. The short-range radio signal transmitter 34 of the vehicle 10 can thereby be located precisely. It is also apparent in FIG. 5 that a short-range radio signal 31 emitted by a short-range radio signal transmitter 34 of a moving object 60 can be received by the short-range radio signal receivers 33 of the loading docks 50 in order to monitor the docking area 51 between the specified loading dock 50a and the vehicle 10, and, on detection of the moving object 60, to actuate an appropriate response such as the output of a warning message to the specified loading dock 50a and/or the transmission of relevant information to the vehicle 10. Optionally, the short-range radio signal 31 of the moving object 60 can comprise an object label, so that the moving object 60 can be classified and/or identified and thus the response can be adapted to a category of the moving object 60.

The sixth exemplary embodiment, which is depicted in FIG. 6 and in which the vehicle 10 is approaching the specified loading dock 50a in a reverse driving direction 11, shall be used to illustrate in particular a second possible locating principle by means of the short-range radio communication 30. In this case, the loading dock 50 each have a short-range radio signal receiver 33. These can be configured to capture the signal incident angle a of the short-range radio transmitter 34 of the vehicle 10. The short-range radio receiver 33 of the specified loading dock 50a is configured to perform signal-based transmitter distance determination, for instance by transmitting a suitable, in particular Bluetooth-based, locating signal request to the short-range radio transmitter 34 of the vehicle 10, which responds with a suitable locating signal response. This can facilitate accurate locating of the vehicle 10 using just a single short-range radio receiver 33.

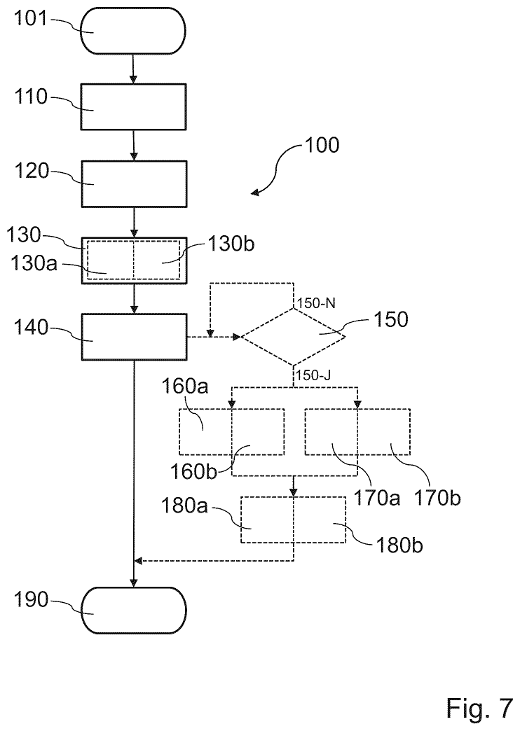

FIG. 7 presents again in the form of a simplified flow diagram the above-described features and options of the method 100 for assisting a docking procedure by the vehicle 10 to the specified loading dock 50a. Optional method steps are marked here in dashed form. The method 100 begins, after a start 101 of the method 100, with establishing 110 short-range radio communication 30 between the loading docks 50 and a vehicle 10, which is arriving at the logistics facility 80, using a short-range radio signal 31 containing an identifier 32. On the basis of the identifier 32 of the short-range radio signal 31, identifying 120 the specified loading dock 50a and/or the vehicle 10 takes place.

On the basis of a signal incident angle a of the short-range radio signal 31, locating 130 the specified loading dock 50a and/or the vehicle 10 then takes place, for instance by performing a triangulation method 130a or signal-based transmitter distance determination 130b. The locating 130 can proceed, in particular continuously, during a subsequent drive-up procedure 140 to the specified loading dock 50a in order to facilitate navigation of the vehicle 10 using the short-range radio signal 31. Depending on whether the vehicle 10 is a conventional vehicle 10 or a semi-automated or fully automated vehicle 10, the driving-up 140 to the specified loading dock 50a can be carried out using the short-range radio signal 31 for navigation by the output of control instructions to the driver or by an automatic drive-up procedure through intervention by the control unit 20 in the control functions of the vehicle 10.

Optionally, a docking area 51 between the specified loading dock 50a and the vehicle 10 can be monitored 150 during the driving-up 140 to the specified loading dock 50a for an existing or likely presence of a moving object 60 that has a short-range radio transmitter 34. If a moving object 60 is not detected 150-N during the monitoring 150, the monitoring 150 can continue to the end 190 of the method 100, which can coincide with contact being made between the specified loading dock 50a and the vehicle 10. If a moving object 60 is detected 150-J during the monitoring 150, then in response to the detection 150-J of the moving object 60 that is currently or likely to be present in the docking area 51, a braking procedure 180a can be initiated at the vehicle 10 and/or a warning message can be output 180b at the vehicle 10 and/or at the specified loading dock 50a. Optionally, classifying 160a and/or identifying 160b the moving object 60 and/or object locating 170a and/or a trajectory calculation 170b can precede the responses. If no monitoring 150 is carried out for an existing or likely presence of a moving object 60 having a short-range radio transmitter 34, the method 140 can be concluded with the end 190 of the method 100 also without monitoring 150 by contact being made between the specified loading dock 50a and the vehicle 10 during the drive-up procedure 140.

The control unit 20 of the vehicle 10 can have a computing unit (not presented in greater detail) and a memory unit. In the memory unit can be held a computer program (not presented in greater detail), which comprises machine-readable instructions which, on execution of the instructions by the computing unit of the control unit 20 cause this to perform the above-described method 100.

Alternatively or additionally, UWB technology (ultra-wideband) can be employed as the short-range radio communication. This radio communication technology involves emitting very short pulses. These pulse consist of just a few short oscillations and then have already decayed away. The total duration equals, for instance, just 0.9 ns. Frequencies from a very wide spectrum of approximately 2 GHz are needed in order to generate such a pulse. The individual frequencies are consequently emitted at a very low signal strength so that they cause practically no interference to other radio transmissions at the same frequency. An advantage of this short-range radio technology is that distances can be measured with high accuracy by means of time-of-flight measurements. This can likewise be employed for locating the loading docks. By ascertaining in the front and/or rear region of the vehicle the distances to a transmitter of a loading dock, it is possible to ascertain equally accurately the relative position of the vehicle to the loading dock.

A further embodiment of the disclosure can consist in the combined use of Bluetooth and UWB communication. The Bluetooth communication is used to ascertain the signal incident angle. The UWB communication is used to ascertain the distance by means of the time-of-flight measurement. The exact position of the vehicle relative to the loading dock can be ascertained by triangulation. The accuracy of the position determination can be increased by the combined solution because a plurality of triangulation calculations can be performed and the results can be averaged or fused.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCES (PART OF THE DESCRIPTION)

10 vehicle
10a commercial vehicle
11 driving direction
20 control unit (vehicle)
21 control means (loading docks)
30 short-range radio communication
31 short-range radio signal
31a Bluetooth signal
32 identifier
33 short-range radio receiver
34 short-range radio transmitter
50 loading dock
50a specified loading dock
51 docking area
60 moving object
80 logistics facility
100 method for assisting a docking procedure
101 start
110 establishing short-range radio communication
120 identifying the specified loading dock
130 locating the specified loading dock
130a triangulation method
130b signal-based transmitter distance determination
140 driving up to the specified loading dock
150 monitoring the docking area
150-J detection of a moving object
150-N no detection of a moving object
160a classifying the moving object
160b identifying the moving object
170a object locating
170b trajectory calculation
180a initiation of braking procedure
180b output of warning message
190 end
α signal incident angle

1. A method for assisting a docking procedure by a vehicle to a specified loading dock of a logistics facility having a plurality of loading docks, comprising:
establishing short-range radio communication between the loading docks and the vehicle using a short-range radio signal including an identifier;
identifying the specified loading dock and/or the vehicle based on the identifier in the short-range radio signal;
locating the specified loading dock and/or the vehicle based on at least one signal incident angle (α) of the short-range radio signal and/or at least one time-of-flight measurement of the short-range radio signal; and
driving up to the specified loading dock using the short-range radio signal for navigating the vehicle to the specified loading dock.

2. The method as claimed in claim 1, wherein the short-range radio communication is based on Bluetooth communication and the short-range radio signal is in a form of a Bluetooth signal.

3. The method as claimed in claim 1 wherein the vehicle has at least one short-range radio receiver and that the loading docks each have at least one short-range radio transmitter.

4. The method as claimed in claim 1, wherein the vehicle has at least one short-range radio transmitter and that the loading docks each have at least one short-range radio receiver.

5. The method as claimed in claim 1, wherein a triangulation method is performed for locating the specified loading dock and/or the vehicle based on the signal incident angle (α) of the short-range radio signal.

6. The method as claimed in claim 1, wherein the locating of the specified loading dock and/or the vehicle is performed based on at least one signal-based transmission distance determination.

7. The method as claimed in claim 1, wherein a docking area between the specified loading dock and the vehicle is monitored during the driving up to the specified loading dock for an existing or likely presence of a moving object that has a short-range radio transmitter.

8. The method as claimed in claim 7, wherein on detection of the moving object present in the docking area, classification and/or identification of the moving object is carried out.

9. The method as claimed in claim 7, wherein on detection of the moving object present in the docking area, object locating and/or a trajectory calculation of the moving object is carried out.

10. The method as claimed in claim 9, wherein in response to the detection of the moving object present in the docking area, a braking procedure is initiated at the vehicle and/or a warning message is output at the vehicle and/or at the specified loading dock.

11. A control unit for the vehicle which is connectable or connected for signal communication to a short-range radio receiver and/or a short-range radio transmitter of the vehicle, and is configured to perform the method as claimed in claim 1.

12. A vehicle having at least one short-range radio receiver and/or at least one short-range radio transmitter (34) and the control unit as claimed in claim 11.

13. The vehicle as claimed in claim 12, wherein the vehicle is in a form of a semi-automated or fully automated vehicle, and is configured for an automatic drive-up procedure to the specified loading dock using the short-range radio signal.

14. A computer program comprising machine-readable instructions which, on execution of instructions by a computing unit cause performance of the method as claimed in claim 1.

15. The method as claimed in claim 1, wherein the vehicle is a commercial vehicle.
